(19) United States
(12) Patent Application Publication
(10) Pub. No.: US 2024/0289692 A1
(43) Pub. Date: Aug. 29, 2024

(54) INFORMATION PROCESSING APPARATUS AND INFORMATION PROCESSING METHOD

(71) Applicant: Kioxia Corporation, Tokyo (JP)

(72) Inventors: Satoru YOKOTA, Yokohama Kanagawa (JP); Ryota YOSHIZAWA, Yokohama Kanagawa (JP); Yusuke UMEZAWA, Yokohama Kanagawa (JP)

(73) Assignee: Kioxia Corporation, Tokyo (JP)

(21) Appl. No.: 18/588,490

(22) Filed: Feb. 27, 2024

(30) Foreign Application Priority Data
Feb. 28, 2023 (JP) 2023-030138

(51) Int. Cl. G06N 20/00

(52) U.S. Cl. CPC G06N 20/00

(57) ABSTRACT

An information processing apparatus comprising processing circuitry, the processing circuitry configured to train a prediction model based on a data set in which a setting value of a parameter and an evaluation value of the setting value are combined, generate a second range narrower than a first range that is a maximum variable range of the setting value inputtable to the prediction model based on the data set and the trained prediction model, shift the second range to include a center value of the first range, and calculate a new setting value to be evaluated next, based on an acquisition function optimized by inputting the setting value within the shifted second range to the trained prediction model.

### CROSS REFERENCE TO RELATED APPLICATIONS

This application is based upon and claims the benefit of priority from the prior Japanese Patent Application No. 2023-030138, filed on Feb. 28, 2023, the entire contents of which are incorporated herein by reference.

### FIELD

An embodiment of the present invention relates to an information processing apparatus and an information processing method.

### BACKGROUND

A technique for searching for an optimum setting value of a parameter by using an evaluation value of a setting value of the parameter is proposed. In order to efficiently solve a high-dimensional parameter optimization problem, a method of performing optimization while adjusting a search range has been proposed. In a case where a method of setting the search range is not appropriate, a calculation time until the optimization is performed may be long. In particular, when the number of dimensions of the parameter is large and the number of pieces of search data is increased, the calculation time tends to increase. In addition, optimization cannot always be performed correctly depending on the type of a variable constituting the parameter.

### BRIEF DESCRIPTION OF THE DRAWINGS

FIG. 1 is a block diagram illustrating a schematic configuration of an information processing apparatus according to a first embodiment;

FIG. 2 is a diagram illustrating an example of normalization of a setting value and an evaluation value constituting a data set;

FIG. 3 is a flowchart illustrating a processing operation of the information processing apparatus according to the first embodiment;

FIG. 4 is a diagram illustrating processing of a local search range generation unit;

FIG. 5 is a block diagram illustrating a schematic configuration of an information processing apparatus according to a comparative example;

FIG. 6 is a flowchart illustrating a processing operation of the information processing apparatus of FIG. 5;

FIG. 7 is a diagram illustrating processing of a local search range generation unit in the information processing apparatus according to the comparative example;

FIG. 8 is a flowchart illustrating a processing operation of a recommendation setting value determination unit according to a second embodiment;

FIG. 9A is a diagram illustrating processes of Steps S30 and S31 in FIG. 8;

FIG. 9B is a diagram in which processing of a local search range generation unit is compared between the second embodiment and the comparative example;

FIG. 10 is a flowchart illustrating a processing operation of a recommendation setting value determination unit according to a third embodiment;

FIG. 11A is a diagram illustrating an example of shift setting of a local search range Xlocal in a case where the setting value when the evaluation value takes the best value is smaller than 0.5;

FIG. 11B is a diagram illustrating an example of shift setting of the local search range Xlocal in a case where the setting value when the evaluation value takes the best value is equal to or more than 0.5;

FIG. 12 is a flowchart illustrating a processing operation of a recommendation setting value determination unit according to a fourth embodiment;

FIG. 13A is a diagram illustrating an example in which a center value of the local search range is shifted to the right by a difference between a center value of a parameter search range and an upper limit value of the local search range;

FIG. 13B is a diagram illustrating an example in which the center value of the local search range is shifted to the left by a difference between a lower limit value of the local search range and the center value of the parameter search range;

FIG. 14 is a flowchart illustrating a processing operation of a recommendation setting value determination unit according to a fifth embodiment;

FIG. 15A is a diagram illustrating an example in which the upper limit value of the local search range is shifted to the right by the difference between the center value of the parameter search range and the upper limit value of the local search range; and

FIG. 15B is a diagram illustrating an example in which the lower limit value of the local search range Xlocal is shifted to the left by the difference between the lower limit value of the local search range and the center value of the parameter search range.

### DETAILED DESCRIPTION

According to one embodiment, an information processing apparatus comprising processing circuitry, the processing circuitry configured to train a prediction model based on a data set in which a setting value of a parameter and an evaluation value of the setting value are combined, generate a second range narrower than a first range that is a maximum variable range of the setting value inputtable to the prediction model based on the data set and the trained prediction model, shift the second range to include a center value of the first range, and calculate a new setting value to be evaluated next, based on an acquisition function optimized by inputting the setting value within the shifted second range to the trained prediction model.

Hereinafter, embodiments of an information processing apparatus and an information processing method will be described with reference to the drawings. Although main components of the information processing apparatus will be mainly described below, the information processing apparatus may have components and functions that are not illustrated or described. The following description does not exclude components and functions that are not illustrated or described.

### First Embodiment

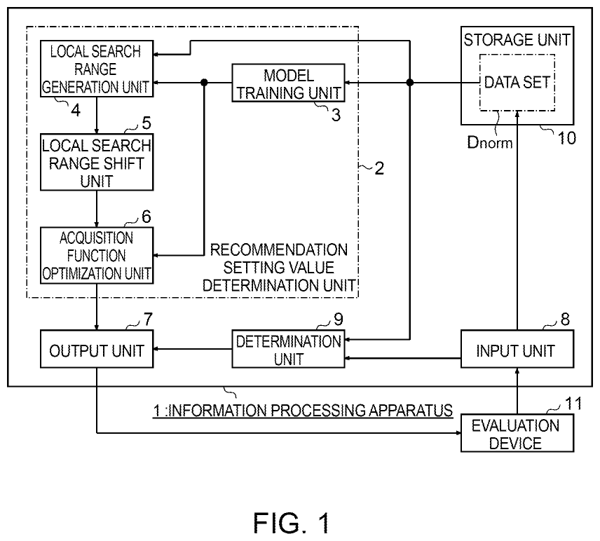

FIG. 1 is a block diagram illustrating a schematic configuration of an information processing apparatus 1 according to a first embodiment. The information processing apparatus 1 in FIG. 1 includes a recommendation setting value determination unit 2. The recommendation setting value determination unit 2 includes a model training unit 3, a local search range generation unit 4, a local search range shift unit 5, and an acquisition function optimization unit 6.

The model training unit 3 trains a prediction model based on a data set in which a setting value of a parameter and an evaluation value of the setting value are combined. The setting value of the parameter is, for example, a setting value of a power supply voltage of a memory cell, a setting value in a reading/writing mode of the memory cell, or the like, and is not limited to a specific setting value. The evaluation value is a value representing the reliability of the setting value, for example, performance such as a reading/writing speed of the memory, an error rate of reading/writing of the memory, or the like.

The local search range generation unit 4 generates a local search range narrower than a parameter search range that is a maximum variable range of setting values that can be input to the prediction model, based on the data set and the prediction model trained by the model training unit 3. In the present specification, the parameter search range may be referred to as a first range, and the local search range may be referred to as a second range. Any specific form of the prediction model is used, and, for example, a Gaussian process regression model, a Lasso regression model, or the like can be applied as the prediction model.

The local search range generation unit 4 may expand or contract the width of the local search range based on the length scale of the prediction model. The length scale is a reciprocal of sensitivity indicating how much the evaluation value changes with respect to the change in the setting value.

For example, the local search range shift unit 5 shifts the local search range to include the center value of the parameter search range. The local search range shift unit 5 may or may not change the width of the local search range before and after shifting the local search range. The local search range shift unit 5 may shift the local search range from a state in which the center value of the parameter search range falls within the local search range, or may shift the local search range from a state in which the center value of the first range does not fall within the second range, to a state in which the center value of the first range falls within the second range.

The acquisition function optimization unit 6 calculates a new setting value to be evaluated next, based on an acquisition function optimized by inputting the setting value within the local search range to the prediction model trained by the model training unit 3.

In addition, the information processing apparatus 1 in FIG. 1 may include an output unit 7, an input unit 8, a determination unit 9, and a storage unit 10.

The output unit 7 outputs the new setting value calculated by the acquisition function optimization unit 6. The setting value output from the output unit 7 is input to an evaluation device 11, and an evaluation value is calculated. The evaluation device 11 may be a simulator. The evaluation device 11 is disposed separately from the information processing apparatus 1 in FIG. 1. The evaluation device 11 may be provided inside the information processing apparatus 1. The evaluation value calculated by the evaluation device 11 is acquired by the input unit 8. The evaluation value acquired by the input unit 8 is stored in the storage unit 10 together with the corresponding setting value.

The determination unit 9 determines whether or not to determine an optimum setting value based on the evaluation value and a predetermined end condition. A series of processes of the model training unit 3, the local search range generation unit 4, the local search range shift unit 5, and the acquisition function optimization unit 6 is repeated until the determination unit 9 determines to determine the optimum setting value. In the present specification, one repetition of this series of processes is referred to as an iteration.

While repeating a series of processes, the local search range generation unit 4 generates the new local search range based on the new setting value calculated by the acquisition function optimization unit 6, regardless of the local search range generated in the series of processes executed immediately before.

The series of processes may be repeatedly executed until the determination unit 9 determines the optimum setting value. Alternatively, the series of processes may be executed in a case where the local search range does not include the center value of the parameter setting range. Alternatively, the series of processes may be executed until the number of times of the series of processes being executed reaches a predetermined number.

The storage unit 10 stores a data set in which the setting value and the corresponding evaluation value are combined. A new data set is stored in the storage unit 10 every iteration.

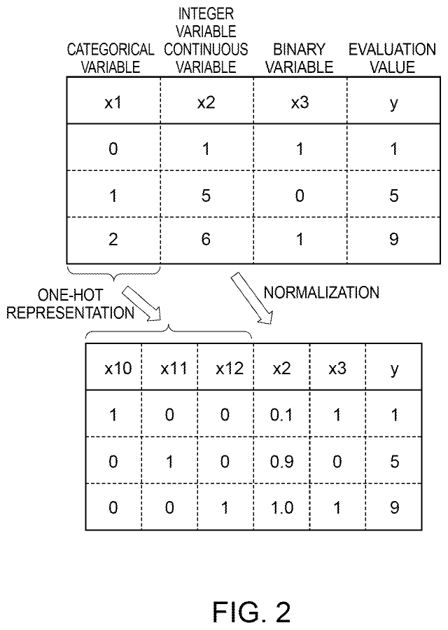

The model training unit 3 may train the prediction model based on a value obtained by normalizing the setting value and the evaluation value constituting the data set. FIG. 2 is a diagram illustrating an example of normalization of the setting value and the evaluation value constituting the data set. The setting value constituting the data set includes at least one of a categorical variable, an integer variable, a continuous variable, or a binary variable. FIG. 2 illustrates an example of a data set in which three setting values including a categorical variable, an integer variable, and a binary variable are combined with an evaluation value. The setting value may be referred to as an explanatory variable, and the evaluation value may be referred to as an objective variable.

The categorical variable is, for example, a bit string including 0 and 1, and each bit string represents a different level. In the example of FIG. 2, a categorical variable x10=[1, 0, 0], a variable x11=[0, 1, 0], and a variable x12=[0, 0, 1] in which each of levels x1=0, 1, and 2 is made in one-hot representation are illustrated.

FIG. 2 illustrates an example in which integer variables x2=1, 5, and 6 are normalized to obtain continuous variables x2=0.1, 0.9, and 1.0 from 0 to 1.

Furthermore, as illustrated in FIG. 2, even if the binary variables x3=1, 0, and 1 are normalized, the variables x3=1, 0, and 1 are obtained as they are. For example, the evaluation value y may be standardized by dividing a value obtained by subtracting an average of the evaluation values y from the evaluation value y by a standard deviation of the evaluation value. Copula transformation or logarithmic transformation in which the magnitude is transformed in accordance with the standard normal distribution may be performed while storing rank information of the magnitude of the evaluation value y.

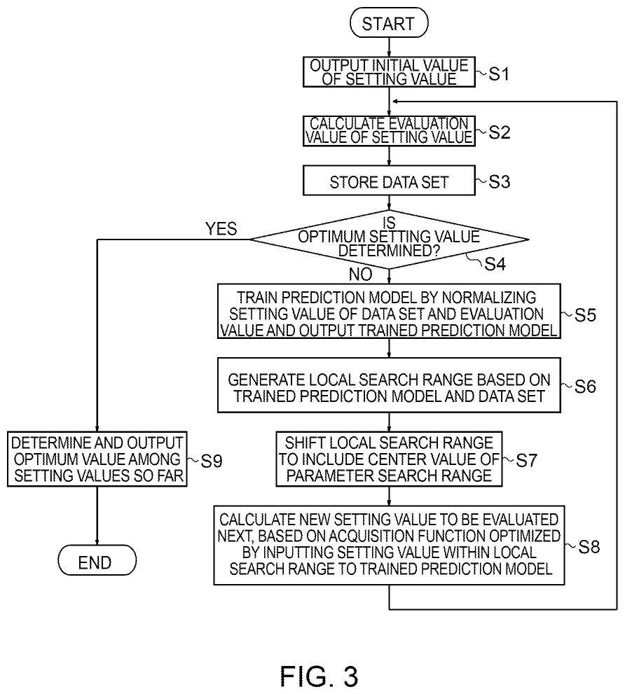

FIG. 3 is a flowchart illustrating a processing operation of the information processing apparatus 1 according to the first embodiment. First, the acquisition function optimization unit 6 outputs an initial value of a setting value of a parameter (Step S1). The initial value is output from the output unit 7 and input to the evaluation device 11. As will be described later, the information processing apparatus 1 according to the present embodiment repeatedly performs the processing of the flowchart in FIG. 3, and the output unit 7 outputs the setting value each time.

The evaluation device 11 calculates an evaluation value of the setting value output from the output unit 7 (Step S2). The evaluation device 11 performs a simulation or an experiment based on the input setting value, and calculates the evaluation value based on a simulation result or an experiment result. In a case where the input setting value is the initial value, the evaluation device 11 calculates an evaluation value corresponding to the initial value.

The input unit 8 acquires the evaluation value calculated by the evaluation device 11. The storage unit 10 stores a data set in which the setting value output from the output unit 7 and the evaluation value that has been calculated by the evaluation device 11 and acquired by the input unit 8 are combined (Step S3). The storage unit 10 stores a new data set each time the information processing apparatus 1 repeats the iteration.

Then, the determination unit 9 determines whether or not to determine an optimum setting value based on the evaluation value of the data set newly stored in the storage unit 10 and a predetermined end condition (Step S4). As described above, the end condition has any specific content. Examples of the end condition include a case where the number of iterations reaches a predetermined number, a case where the elapsed time from the start of the processing in FIG. 3 reaches a predetermined time, a case where the same setting value is continuously set a predetermined number of times or more, or the like.

When it is determined in Step S4 that the optimum setting value is not determined, the model training unit 3 trains a prediction model based on the setting value constituting the data set and a value obtained by normalizing the evaluation value, and outputs the trained prediction model (Step S5).

Then, the local search range generation unit 4 generates a local search range based on the trained prediction model and the data set (Step S6). The local search range generation unit 4 may or may not expand or contract the local search range every iteration.

Then, the local search range shift unit 5 shifts the local search range to include the center value of the parameter search range (Step S7). As described above, since the local search range is shifted to include the center value of the parameter search range, there is no concern that the local search range is shifted to a range that deviates from the parameter search range, and it is possible to narrow the setting value down in a short time.

Then, the acquisition function optimization unit 6 calculates a new setting value to be evaluated next, based on an acquisition function optimized by inputting the setting value within the local search range to the trained prediction model (Step S8). Thereafter, the processes in and after Step S2 are repeated.

On the other hand, in a case where the determination in Step S4 is YES, the optimum value is determined from the setting values so far and output (Step S9).

A series of processes in Steps S2 to S8 of FIG. 3 is one iteration, and the iteration is repeated a plurality of times until the determination unit 9 determines the optimum setting value.

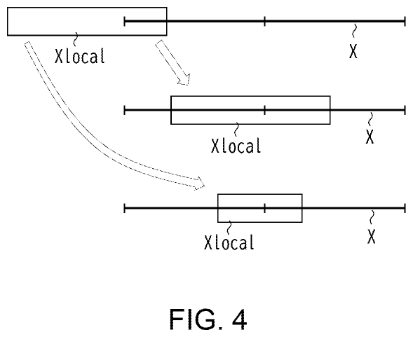

FIG. 4 is a diagram illustrating processing of the local search range generation unit 4. The upper part of FIG. 4 illustrates an example in which a local search range Xlocal does not include the center value of a parameter search range X. In this case, as illustrated in the middle part of FIG. 4, the local search range generation unit 4 shifts the local search range Xlocal to the right side to include the center value of the parameter search range X without changing the width of the local search range Xlocal. Alternatively, as illustrated in the lower part of FIG. 4, the local search range generation unit 4 may change the width of the local search range Xlocal and shift the local search range Xlocal to the right side to include the center value of the parameter search range X.

FIG. 4 illustrates an example in which an upper limit value of the local search range Xlocal is provided on the left side of the center value of the parameter search range X in the initial state illustrated in the upper part. In a case where a lower limit value of the local search range Xlocal is provided on the right side of the center value of the parameter search range X, the local search range Xlocal is shifted to the left side to include the center value of the parameter search range X.

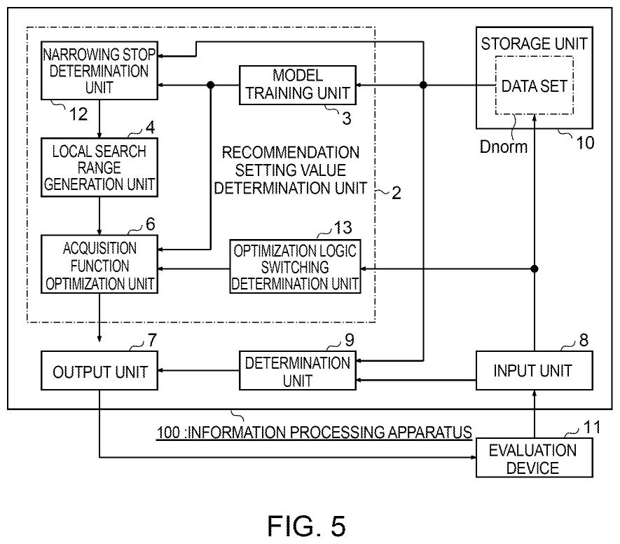

FIG. 5 is a block diagram illustrating a schematic configuration of an information processing apparatus 100 according to a comparative example. In the information processing apparatus 100 in FIG. 5, components common to those in FIG. 1 are denoted by the same reference signs, and differences will be mainly described below.

The information processing apparatus 100 in FIG. 5 does not include the local search range shift unit 5 in the information processing apparatus 1 in FIG. 1. Furthermore, the information processing apparatus 100 in FIG. 5 includes a narrowing stop determination unit 12 and an optimization logic switching determination unit 13 that are not provided in the information processing apparatus 1 in FIG. 1.

The narrowing stop determination unit 12 determines whether or not the width of the local search range Xlocal is too narrow. In a case where the width of the local search range Xlocal is too narrow, the narrowing stop determination unit 12 stops narrowing the local search range Xlocal. When the width of the local search range Xlocal is too narrow, the optimization logic switching determination unit 13 determines whether or not to generate the local search range Xlocal in another place and perform the optimization process again.

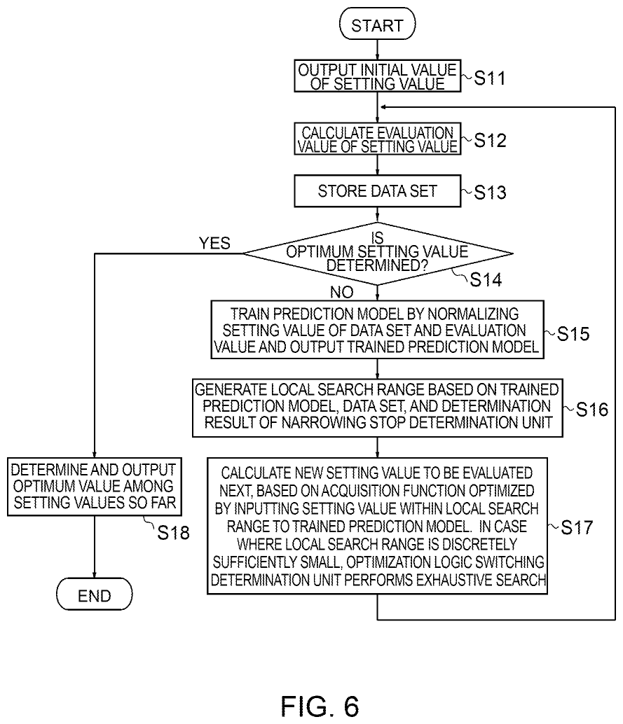

FIG. 6 is a flowchart illustrating a processing operation of the information processing apparatus 100 of FIG. 5. Steps S11 to S15 in FIG. 6 are common to Steps S1 to S5 in FIG. 3. When the trained prediction model is output in Step S15, the local search range generation unit 4 generates the local search range Xlocal based on the trained prediction model, the data set, and the determination result of the narrowing stop determination unit 12 (Step S16). More specifically, in a case where the width of the local search range Xlocal is too narrow, the local search range generation unit 4 generates the local search range Xlocal in another place.

Then, the acquisition function optimization unit 6 calculates a new setting value to be evaluated next, based on an acquisition function optimized by inputting the setting value within the local search range Xlocal to the trained prediction model (Step S17). More specifically, in a case where the local search range Xlocal is discretely sufficiently small, the narrowing stop determination unit 12 stops the narrowing of the local search range Xlocal, and the acquisition function optimization unit 6 performs the exhaustive search based on the determination of the optimization logic switching determination unit 13. Thereafter, the processes in and after Step S12 are repeated.

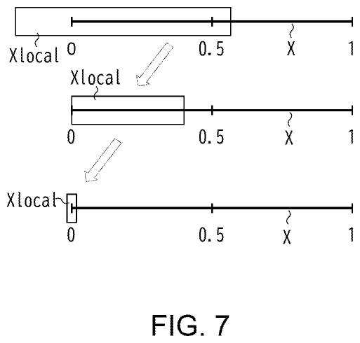

FIG. 7 is a diagram illustrating processing of the local search range generation unit 4 in the information processing apparatus 100 according to the comparative example. In a case where the local search range Xlocal protrudes to the lower side of, for example, the lower limit value of the parameter search range X, as illustrated in the middle part of FIG. 7, the lower limit value of the local search range Xlocal is shifted to the lower limit value of the parameter search range X. When the lower limit value of the local search range Xlocal is selected as the best value, as illustrated in the lower part of FIG. 7, there is a concern that the width of the local search range Xlocal is rapidly reduced, and thus only a specific value within the parameter search range X can be selected. Therefore, by providing the narrowing stop determination unit 12, and the narrowing is stopped in a case where the width of the local search range Xlocal is too small. The optimization logic switching determination unit 13 exhaustively searches for another place and sets the local search range Xlocal in the searched place.

The information processing apparatus 100 according to the comparative example illustrated in FIGS. 5 to 7 may not be able to appropriately set the local search range Xlocal as compared with the information processing apparatus 1 according to the first embodiment illustrated in FIGS. 1 to 4. When the optimization logic switching determination unit 13 re-sets the local search range Xlocal in another place, it takes time to execute an optimization process of the setting value. In addition, the information processing apparatus 100 according to the comparative example may not be able to process a specific variable such as the categorical variable for the setting value included in the data set.

As described above, in the first embodiment, when the acquisition function is optimized by inputting the setting value within the local search range Xlocal to the prediction model, the local search range Xlocal is shifted to include the center value of the parameter search range X. Therefore, it is possible to appropriately narrow the local search range Xlocal down, and it is unlikely to cause a problem that the local search range Xlocal is fixed to a specific point or a problem that the width of the local search range Xlocal is rapidly narrowed. Therefore, it is possible to quickly and accurately optimize the setting value.

### Second Embodiment

A second embodiment is different from the first embodiment in the processing operation of the local search range generation unit 4. An information processing apparatus 1 according to the second embodiment has a block configuration similar to that in FIG. 1.

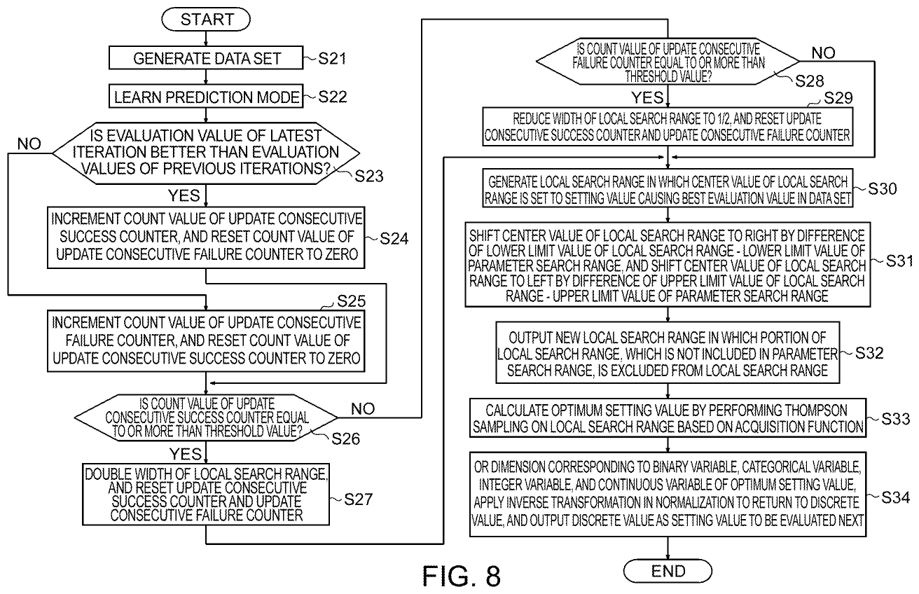

FIG. 8 is a flowchart illustrating a processing operation of the recommendation setting value determination unit 2 in the information processing apparatus 1 according to the second embodiment. The information processing apparatus 1 according to the second embodiment performs processing of the flowchart of FIG. 8 in a case where the determination in Step S4 of FIG. 3 is NO. That is, the flowchart of FIG. 8 illustrates details of the processes of Steps S5 to S8 and Step S2 in FIG. 3.

First, the model training unit 3 generates a data set including a setting value and an evaluation value (Step S21). More specifically, the model training unit 3 sets the binary variable to 0 or 1, sets the categorical variable to one-hot representation, normalizes the integer variable and the continuous variable, and generates a data set Dnorm in which the search range X is transformed into [0, 1]^{d}∈R^{d}.

Then, the model training unit 3 performs Gaussian process regression with the setting value as the explanatory variable x and the evaluation value as the objective variable y in the data set Dnorm, and learns a prediction model y=f_{pred}(x) of the Gaussian process regression (Step S22).

Next, the local search range generation unit 4 determines whether or not the evaluation value of the latest iteration is better than the best value of the evaluation values of the previous iterations based on the data set Dnorm of the latest iteration (Step S23). In a case where the determination in Step S23 is YES, the count value of an update consecutive success counter is incremented, and the count value of an update consecutive failure counter is reset to zero (Step S24). In a case where the determination in Step S23 is NO, the count value of the update consecutive failure counter is incremented, and the count value of the update consecutive success counter is reset to zero (Step S25).

When the process of Step S24 or S25 is ended, the local search range generation unit 4 determines whether or not the count value of the update consecutive success counter is equal to or more than a predetermined threshold value (Step S26). In a case where the determination in Step S26 is YES, the width L of the local search range Xlocal is doubled, and the count values of the update consecutive success counter and the update consecutive failure counter are both reset to zero (Step S27).

In a case where the determination in Step S26 is NO, it is determined whether or not the count value of the update consecutive failure counter is equal to or more than a predetermined threshold value (Step S28). In a case where the determination in Step S28 is YES, the width L of the local search range Xlocal is reduced to ½, and the count values of the update consecutive success counter and the update consecutive failure counter are both reset to zero (Step S29).

In this manner, the width of the local search range Xlocal is widened in a case where the evaluation value is enhanced in a predetermined number of consecutive iterations, and the width of the local search range is narrowed in a case where the evaluation value is deteriorated in the predetermined number of consecutive iterations.

In a case where the process of Step S27 or S29 is ended or in a case where the determination in Step S28 is NO, the local search range generation unit 4 generates a local search range Xlocal in which the center value x_{center} of the local search range Xlocal is set to a setting value causing the best evaluation value in the data set Dnorm (Step S30).

Then, in a case where the lower limit value of the local search range Xlocal is smaller than the lower limit value of the parameter search range X, the local search range shift unit 5 shifts the center value of the local search range Xlocal to the right by a difference between both the lower limit values. In addition, in a case where the upper limit value of the local search range Xlocal is more than the upper limit value of the parameter search range X, the local search range shift unit 5 shifts the center value of the local search range Xlocal to the left by a difference between both the upper limit values (Step S31). Shifting to the right means shifting in a direction in which the center value of the local search range Xlocal increases. Shifting to the left means shifting in a direction in which the center value decreases.

Then, the local search range shift unit 5 outputs a new local search range Xlocal obtained by excluding a portion of the local search range Xlocal that is not included in the parameter search range X, from the local search range Xlocal (Step S32).

Then, the acquisition function optimization unit 6 calculates an optimum setting value xₒₚₜ by performing Thompson sampling on the local search range Xlocal based on the acquisition function fpred(x) (Step S33).

For the dimension corresponding to the binary variable, the categorical variable, the integer variable, and the continuous variable of the optimum setting value xₒₚₜ, the acquisition function optimization unit 6 applies the inverse transformation in normalization to return to a discrete value, and outputs the discrete value as a setting value to be evaluated next (Step S34).

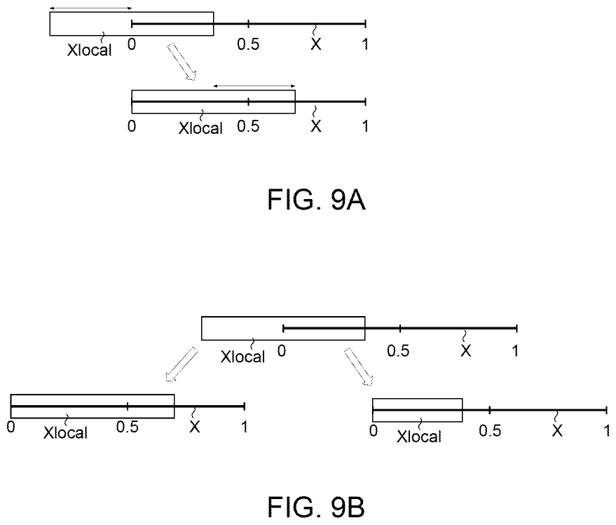

FIGS. 9A and 9B are diagrams illustrating processes of Steps S30 and S31 in FIG. 8. FIG. 9A illustrates an example in which, in a case where the lower limit value of the local search range Xlocal is smaller than the lower limit value of the parameter search range X, the center value of the local search range Xlocal is shifted to the right by a difference between the lower limit value of the local search range Xlocal and the lower limit value of the parameter search range X. As a result, the entire local search range Xlocal is included in the parameter search range X. Furthermore, in the example of FIG. 9A, by shifting the center value of the local search range Xlocal to the right, the center value of the parameter search range X is included in the local search range Xlocal, and thus the setting value can be optimized. In the example of FIG. 9A, the local search range Xlocal is shifted without changing the width of the local search range Xlocal. The local search range Xlocal may be expanded or contracted.

FIG. 9B is a diagram in which the processing of the local search range generation unit 4 is compared between the second embodiment and the comparative example. As illustrated in the lower left of FIG. 9B, in the second embodiment, the local search range Xlocal is shifted to the right (or left) without changing the width of the local search range Xlocal so that the limit value (for example, the lower limit value) of the local search range Xlocal coincides with the limit value (for example, the lower limit value) of the parameter search range X. On the other hand, as illustrated in the lower right of FIG. 9B, the comparative example is the same as the second embodiment in that the lower limit value of the local search range Xlocal is caused to coincide with the lower limit value of the parameter search range X. However, the width of the local search range Xlocal is shortened, and thus the center value of the parameter search range X may not be included in the local search range Xlocal, the values of the binary variable and the categorical variable may be fixed when the inverse transform of Step S34 is applied, and the setting value may not be able to be optimized.

As described above, in the second embodiment, in a case where the lower limit value of the local search range Xlocal is smaller than the lower limit value of the parameter search range X or in a case where the upper limit value of the local search range Xlocal is more than the upper limit value of the parameter search range X, the center value of the local search range Xlocal is shifted to the right or left by the difference between the lower limit value (upper limit value) of the local search range Xlocal and the lower limit value (upper limit value) of the parameter search range X, and the portion of the shifted local search range Xlocal, which protrudes from the lower limit value or the upper limit value of the parameter search range X is excluded from the shifted local search range Xlocal. Therefore, the entire local search range Xlocal can be included in the parameter search range X, and it is possible to quickly and accurately optimize the setting value.

### Third Embodiment

A third embodiment is different from the first or second embodiment in the processing operation of the local search range generation unit 4. The third embodiment is characterized in that the center of the local search range Xlocal is necessarily caused to coincide with the center of the parameter search range X, and the local search range Xlocal is shifted to normally include the center of the parameter search range X in the local search range Xlocal. An information processing apparatus 1 according to the third embodiment has a block configuration similar to that in FIG. 1.

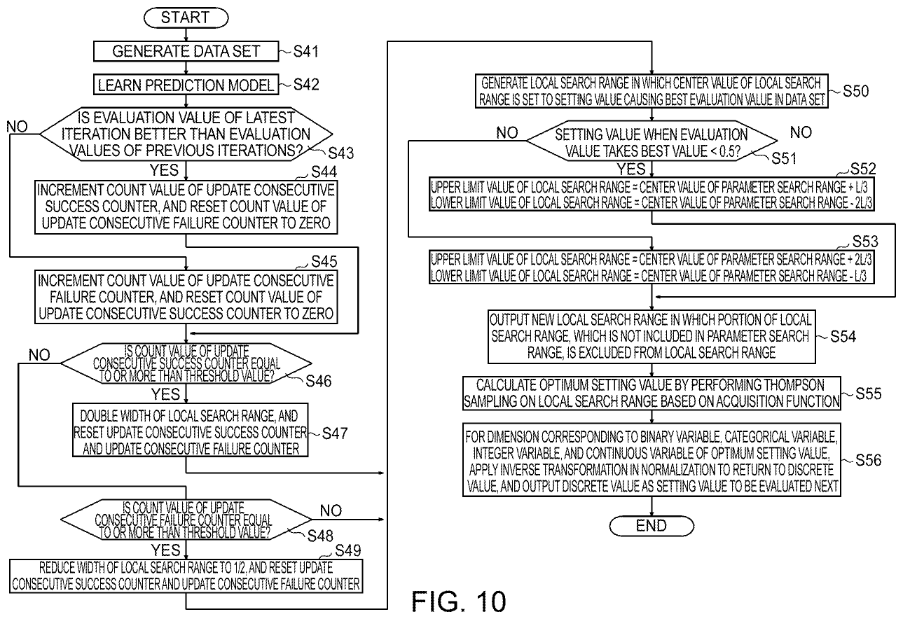

FIG. 10 is a flowchart illustrating a processing operation of the recommendation setting value determination unit 2 in the information processing apparatus 1 according to the third embodiment. Steps S41 to S49 in FIG. 10 execute the similar processes to Steps S21 to S29 in FIG. 8.

In a case where the process of Step S47 or S49 is ended or in a case where the determination in Step S48 is NO, the local search range generation unit 4 generates a local search range Xlocal in which the center value x_{center} of the local search range Xlocal is set as a setting value causing the best evaluation value in the data set Dnorm (Step S50).

Then, for the dimension corresponding to the categorical variable and the binary variable in the local search range Xlocal, the local search range shift unit 5 determines whether or not the setting value when the evaluation value of the data set Dnorm takes the best value is smaller than the center value 0.5 of the parameter search range X (Step S51). Here, it is noted that the center value of the parameter search range X is normalized to be 0.5 when the data set of S41 is created, and the setting value is normalized.

In a case where the determination in Step S51 is YES, the upper limit value of the local search range Xlocal is set to the center value of the parameter search range X+L/3, and the lower limit value of the local search range Xlocal is set to the center value of the parameter search range X−2L/3 (Step S52).

In a case where the determination in Step S51 is NO, the upper limit value of the local search range Xlocal is set to the center value of the parameter search range X+2L/3, and the lower limit value of the local search range Xlocal is set to the center value of the parameter search range X−L/3 (Step S53).

When the process of Step S52 or S53 is ended, the similar processes to Steps S32 to S34 of FIG. 8 are executed (Steps S54 to S56).

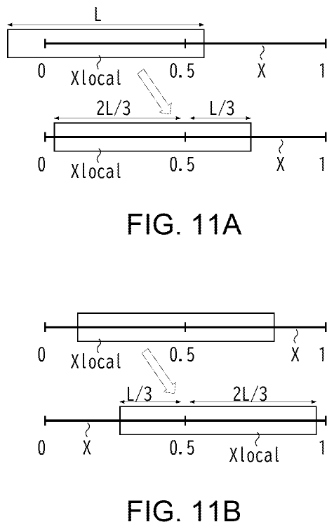

FIGS. 11A and 11B are diagrams illustrating a processing operation of Steps S51 and S53 in FIG. 10. FIGS. 11A and 11B illustrate a process of setting the upper limit and the lower limit of the local search range Xlocal on the assumption that the center value of the parameter search range X is normalized to 0.5. FIG. 11A is a diagram illustrating an example of shift setting of the local search range Xlocal in a case where the setting value when the evaluation value takes the best value is smaller than 0.5. In this case, the upper limit of the local search range Xlocal is set to the center value (=0.5) of the parameter search range X+L/3, and the lower limit of the local search range Xlocal is set to the center value (=0.5)−2L/3.

FIG. 11B is a diagram illustrating an example of shift setting of the local search range Xlocal in a case where the setting value when the evaluation value takes the best value is equal to or more than 0.5. In this case, the upper limit of the local search range Xlocal is set to the center value (=0.5) of the parameter search range X+2L/3, and the lower limit of the local search range Xlocal is set to the center value (=0.5)−L/3.

As described above, the third embodiment is characterized in that the local search range Xlocal is shifted such that the local search range Xlocal normally includes the center value of the parameter search range X. The shift position of the local search range Xlocal is changed depending on whether the setting value when the evaluation value takes the best value is more or smaller than the center value of the parameter search range X. Therefore, it is possible to avoid an occurrence of a situation in which the setting values of the binary variable and the categorical variable are normally fixed when Step S56 described above is executed, and it is possible to set the local search range Xlocal near the optimum value of the setting value.

### Fourth Embodiment

In a fourth embodiment, the local search range Xlocal is shifted such that the center value of the parameter search range X is necessarily included in the local search range Xlocal.

The fourth embodiment is different from the first to third embodiments in the processing operation of the local search range generation unit 4. An information processing apparatus 1 according to the fourth embodiment has a block configuration similar to that in FIG. 1.

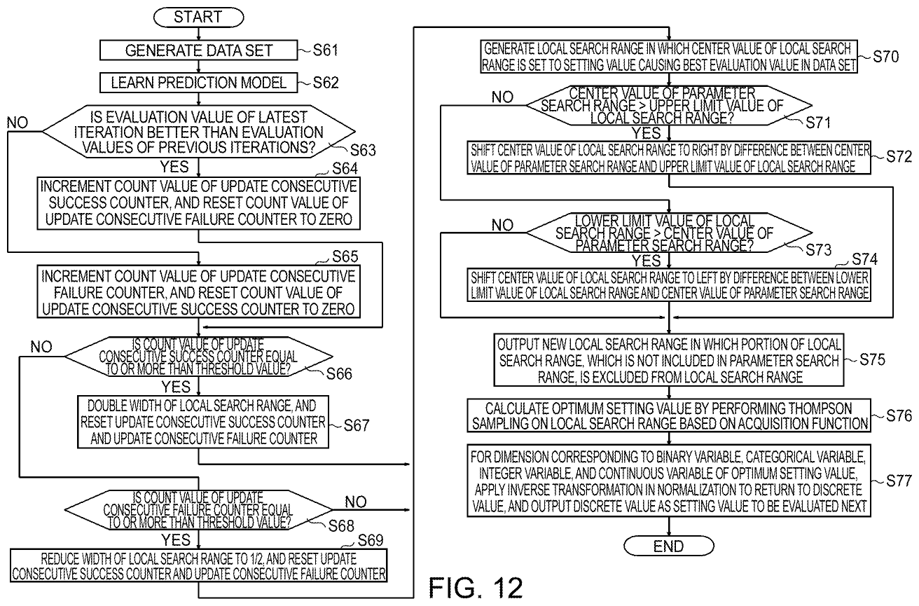

FIG. 12 is a flowchart illustrating a processing operation of the recommendation setting value determination unit 2 in the information processing apparatus 1 according to the fourth embodiment. Steps S61 to S69 in FIG. 12 execute the similar processes to Steps S21 to S29 in FIG. 8.

In a case where the process of Step S67 or S69 is ended or in a case where the determination in Step S68 is NO, the local search range generation unit 4 generates a local search range Xlocal in which the center value x_{center} of the local search range Xlocal is set as a setting value causing the best evaluation value in the data set Dnorm (Step S70).

For the dimension corresponding to the categorical variable and the binary variable in the local search range Xlocal, the local search range shift unit 5 determines whether or not the center value of the parameter search range X is more than the upper limit value of the local search range Xlocal (Step S71). In a case where the determination in Step S71 is YES, the center value of the local search range Xlocal is shifted to the right by a difference between the center value of the parameter search range X and the upper limit value of the local search range Xlocal (Step S72).

In a case where the determination in Step S71 is NO, it is determined whether or not the lower limit value of the local search range Xlocal is more than the center value of the parameter search range X (Step S73). In a case where the determination in Step S73 is YES, the center value of the local search range Xlocal is shifted to the left by a difference between the lower limit value of the local search range Xlocal and the center value of the parameter search range X (Step S74).

In a case where the process in Step S72 or S74 is ended or in a case where the determination in Step S73 is NO, the similar processes to Steps S32 to S34 in FIG. 8 are executed (Steps S75 to S77).

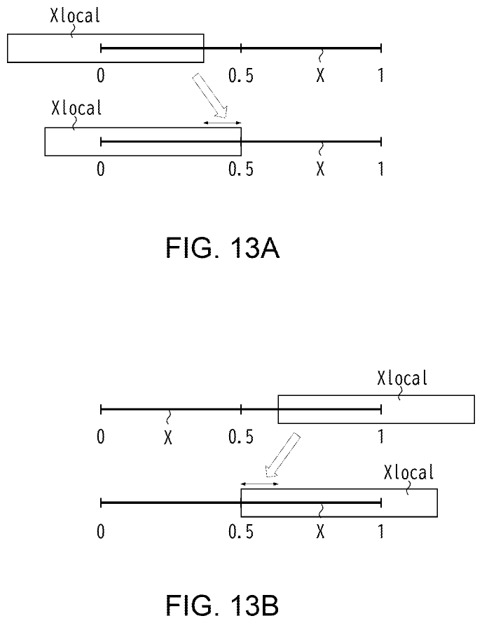

FIGS. 13A and 13B are diagrams illustrating a processing operation of Steps S71 and S74 in FIG. 12. FIG. 13A is a diagram illustrating an example in which the center value of the local search range Xlocal is shifted to the right by the difference between the center value of the parameter search range X and the upper limit value of the local search range Xlocal. FIG. 13B is a diagram illustrating an example in which the center value of the local search range Xlocal is shifted to the left by the difference between the lower limit value of the local search range Xlocal and the center value of the parameter search range X.

As described above, in the fourth embodiment, the center value of the local search range Xlocal is shifted such that the center value of the parameter search range X is necessarily included in the local search range Xlocal. Thus, the center value of the parameter search range X is included in the local search range Xlocal, and the local search range Xlocal does not greatly deviate from the parameter search range X.

### Fifth Embodiment

In a fifth embodiment, the local search range Xlocal is shifted such that the center value of the parameter search range X is necessarily included in the local search range Xlocal.

The fifth embodiment is different from the first to fourth embodiments in the processing operation of the local search range generation unit 4. An information processing apparatus 1 according to the fifth embodiment has a block configuration similar to that in FIG. 1.

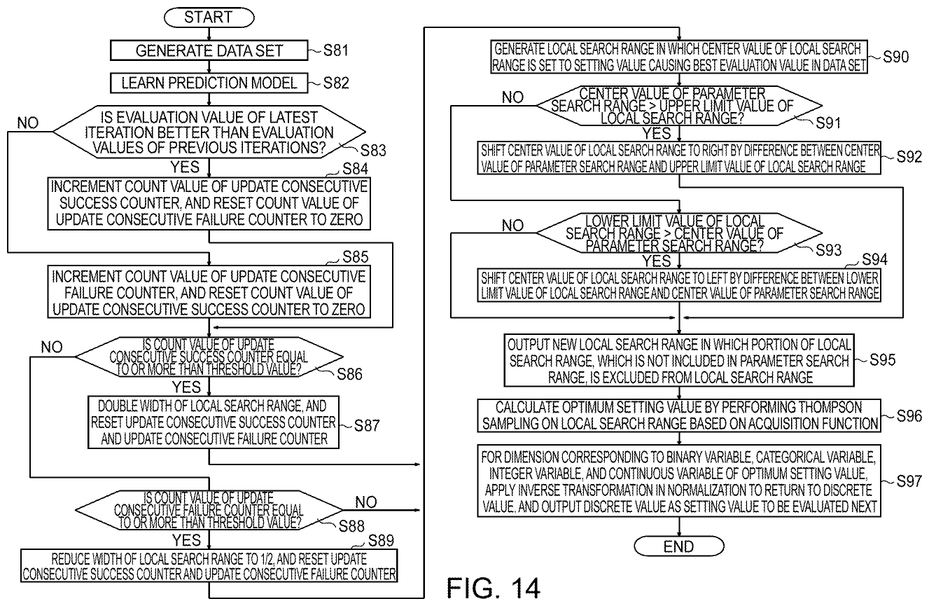

FIG. 14 is a flowchart illustrating a processing operation of the recommendation setting value determination unit 2 in the information processing apparatus 1 according to the fifth embodiment. Steps S81 to S89 in FIG. 14 execute the similar processes to Steps S21 to S29 in FIG. 8.

In a case where the process of Step S87 or S89 is ended or in a case where the determination in Step S88 is NO, the local search range generation unit 4 generates a local search range Xlocal in which the center value x_{center} of the local search range Xlocal is set as a setting value causing the best evaluation value in the data set Dnorm (Step S90).

For the dimension corresponding to the categorical variable and the binary variable in the local search range Xlocal, the local search range shift unit 5 determines whether or not the center value of the parameter search range X is more than the upper limit value of the local search range Xlocal (Step S91). In a case where the determination in Step S91 is YES, the upper limit value of the local search range Xlocal is shifted to the right by a difference between the center value of the parameter search range X and the upper limit value of the local search range Xlocal (Step S92).

In a case where the determination in Step S91 is NO, it is determined whether or not the lower limit value of the local search range Xlocal is more than the center value of the parameter search range X (Step S93). In a case where the determination in Step S91 is YES, the lower limit value of the local search range Xlocal is shifted to the left by a difference between the lower limit value of the local search range Xlocal and the center value of the parameter search range X (Step S94).

In a case where the process in Step S92 or S94 is ended or in a case where the determination in Step S93 is NO, the similar processes to Steps S32 to S34 in FIG. 8 are executed (Steps S95 to S97).

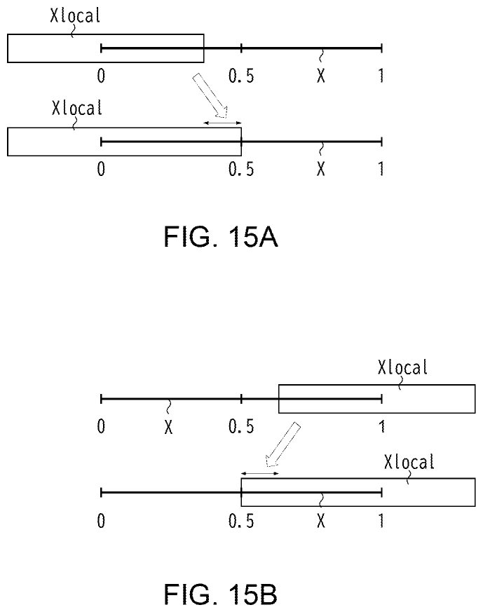

FIGS. 15A and 15B are diagrams illustrating a processing operation of Steps S91 and S94 in FIG. 14. FIG. 15A is a diagram illustrating an example in which the upper limit value of the local search range Xlocal is shifted to the right by the difference between the center value of the parameter search range X and the upper limit value of the local search range Xlocal. FIG. 15B is a diagram illustrating an example in which the lower limit value of the local search range Xlocal is shifted to the left by the difference between the lower limit value of the local search range Xlocal and the center value of the parameter search range X.

As described above, in the fifth embodiment, the upper limit value or the lower limit value of the local search range Xlocal is shifted such that the center value of the parameter search range X is necessarily included in the local search range Xlocal. Thus, the center value of the parameter search range X can be included in the local search range Xlocal by expanding or contracting the width of the local search range Xlocal.

### Sixth Embodiment

In the first to fifth embodiments described above, the example in which the local search range Xlocal is generated and shifted in each of a plurality of iterations until the determination unit 9 determines the optimum setting value has been described. The local search range Xlocal may be generated and shifted in only some iterations.

Although conditions for generating and shifting the local search range Xlocal are freely set, representative first to third conditions will be described here.

The first condition is that, as described in the first to fifth embodiments, the local search range Xlocal is generated and shifted in each of a plurality of iterations performed until the determination unit 9 determines the optimum setting value. In this case, the local search range Xlocal is generated and shifted for each iteration instead of generating and shifting the local search range Xlocal in the next iteration by using the local search range Xlocal generated in the immediately preceding iteration and the shift result.

The second condition is that the local search range Xlocal is generated and shifted in a case where the center value of the parameter search range X is not included in the local search range Xlocal. In the second condition, the local search range Xlocal is generated and shifted only in some iterations, and thus it is possible to speed up the processing.

The third condition is that the local search range Xlocal is generated and shifted until the number of iterations reaches a predetermined number. In the iteration in the final stage, the local search range Xlocal is also narrowed to the vicinity of the optimum value of the setting value. Thus, it is possible to appropriately optimize the setting value without generating and shifting the local search range Xlocal. For example, by generating and shifting the local search range Xlocal only in the early iteration, it is possible to speed up the processing.

### Seventh Embodiment

In the first to sixth embodiments described above, the example in which the setting value is optimized by using the optimization method based on the Gaussian process regression model (may also be referred to as Bayesian optimization) has been described. The prediction model used by the information processing apparatus 1 according to the present disclosure is not applied only to a prediction model that performs Bayesian optimization. For example, a prediction model such as random forest, LightGBM, or XGBoost may be used, or a neural network may be used.

At least a part of the information processing apparatus 1 described in the above-described embodiments may be configured by hardware or software. In a case of being configured by software, a program for realizing the function of at least a part of the information processing apparatus 1 may be stored in a recording medium such as a flexible disk or a CD-ROM, and may be read and executed by a computer. The recording medium is not limited to a removable recording medium such as a magnetic disk or an optical disk, and may be a fixed recording medium such as a hard disk device or a memory.

In addition, the program for realizing the function of at least a part of the information processing apparatus 1 may be distributed via a communication line (including wireless communication) such as the Internet. Further, the program may be distributed via a wired line or a wireless line such as the Internet or by being stored in a recording medium, in an encrypted, modulated, or compressed state.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

1. An information processing apparatus comprising processing circuitry, the processing circuitry configured to:
train a prediction model based on a data set in which a setting value of a parameter and an evaluation value of the setting value are combined;
generate a second range narrower than a first range that is a maximum variable range of the setting value inputtable to the prediction model based on the data set and the trained prediction model;
shift the second range to include a center value of the first range; and
calculate a new setting value to be evaluated next, based on an acquisition function optimized by inputting the setting value within the shifted second range to the trained prediction model.

2. The information processing apparatus according to claim 1, wherein
the second range is shifted without changing a width of the second range from a state in which the center value of the first range does not fall within the second range to a state in which the center value of the first range falls within the second range.

3. The information processing apparatus according to claim 1, wherein
the second range is shifted without changing a width of the second range.

4. The information processing apparatus according to claim 1, wherein
the second range is shifted by expanding or contracting a width of the second range.

5. The information processing apparatus according to claim 1, wherein
the processing circuitry is configured to:
shift the second range without changing a width of the second range or by reducing the width of the second range, such that a lower limit value of the second range becomes equal to or more than a lower limit value of the first range, in a case where the lower limit value of the second range is smaller than the lower limit value of the first range, and
shift the second range without changing the width of the second range or by reducing the width of the second range, such that an upper limit value of the second range becomes equal to or less than an upper limit value of the first range, in a case where the upper limit value of the second range is more than the upper limit value of the first range.

6. The information processing apparatus according to claim 5, wherein
a partial range that no longer overlaps the first range is excluded from the second range when the second range is shifted.

7. The information processing apparatus according to claim 1, wherein
at least one of an upper limit value or a lower limit value of the second range is set based on a magnitude relationship between a setting value at which the evaluation value of the data set is the best and the center value of the first range.

8. The information processing apparatus according to claim 7, wherein
a difference between the center value of the first range and the lower limit value of the second range is set to be more than a difference between the upper limit value of the second range and the center value of the first range in a case where the setting value at which the evaluation value of the data set is the best is smaller than the center value of the first range, and
the difference between the upper limit value of the second range and the center value of the first range is set to be more than the difference between the center value of the first range and the lower limit value of the second range in a case where the setting value at which the evaluation value of the data set is the best is equal to or more than the center value of the first range.

9. The information processing apparatus according to claim 1, wherein
the second range is shifted such that a center value of the second range increases by a difference between the center value of the first range and an upper limit value of the second range, in a case where the center value of the first range is more than the upper limit value of the second range, and
the second range is shifted such that the center value of the second range decreases by a difference between a lower limit value of the second range and the center value of the first range, in a case where the lower limit value of the second range is more than the center value of the first range.

10. The information processing apparatus according to claim 1, wherein
the second range is shifted such that an upper limit value of the second range increases by a difference between the center value of the first range and the upper limit value of the second range, in a case where the center value of the first range is more than the upper limit value of the second range, and
the second range is shifted such that a lower limit value of the second range increases by a difference between the lower limit value of the second range and the center value of the first range, in a case where the lower limit value of the second range is more than the center value of the first range.

11. The information processing apparatus according to claim 1, wherein the processing circuitry is further configured to determine whether or not to determine an optimum setting value based on the evaluation value and a predetermined end condition, wherein
the processing circuitry is configured to repeat series of processes of training the prediction model, generating the second range, shifting the second range, and calculating the new setting value in at least a part of a period until the optimum setting value is determined.

12. The information processing apparatus according to claim 11, wherein
a new second range is generated based on the calculated new setting value, regardless of the second range generated by the series of processes executed immediately before while repeating the series of processes.

13. The information processing apparatus according to claim 11, wherein
the series of processes are repeatedly executed until the optimum setting value is determined.

14. The information processing apparatus according to claim 11, wherein
the series of processes are executed in a case where the second range does not include the center value of the first range.

15. The information processing apparatus according to claim 11, wherein
the series of processes are executed until a number of times of the series of processes being executed reaches a predetermined number.

16. The information processing apparatus according to claim 1, wherein
the setting value includes at least one of a categorical variable, an integer variable, a continuous variable, or a binary variable.

17. The information processing apparatus according to claim 1, wherein the processing circuitry is further configured to:
output the calculated new setting value; and
acquire an evaluation value of the new setting value.

18. The information processing apparatus according to claim 1, wherein the processing circuitry is further configured to:
store a data set in which the new setting value and the corresponding evaluation value are combined.

19. An information processing method causing a computer to execute:
training a prediction model based on a data set in which a setting value of a parameter and an evaluation value of the setting value are combined;
generating a second range narrower than a first range that is a maximum variable range of the setting value inputtable to the prediction model based on the data set and the trained prediction model;
shifting the second range to include a center value of the first range; and
calculating a new setting value to be evaluated next, based on an acquisition function optimized by inputting the setting value within the shifted second range to the trained prediction model.

20. The information processing method according to claim 19, wherein
the second range is shifted without changing a width of the second range from a state in which the center value of the first range does not fall within the second range to a state in which the center value of the first range falls within the second range.
